(19) United States
(12) Patent Application Publication
(10) Pub. No.: US 2006/0149503 A1
(43) Pub. Date: Jul. 6, 2006

(54) Methods and systems for fast least squares optimization for analysis of variance with covariants

(76) Inventor: James M. Minor, Los Altos, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/026,484

(22) Filed: Dec. 30, 2004

(51) Int. Cl. G06F 17/18

(52) U.S. Cl. 702/179

(57) ABSTRACT

Methods, systems and computer readable media for fast linear regression for modeling effects of multiple variables on uni-variable or multi-variable outputs. The techniques are particularly advantageous for large data matrices representing nominal and/or ordinal variables in conjunction with one or more scalar variables. Because nominal variables tend to produce very large, yet very sparse matrices, techniques for condensing such matrices and implementing such condensed matrices in performance of linear regression calculations are also provided.

### BACKGROUND OF THE INVENTION

Analysis of variance (ANOVA) is used to uncover the main and interaction effects of categorical independent variables (sometimes referred to as “factors”) on a dependent variable based on a functional association. Categorical dependents may also be supported. A “main effect” is the individual effect of an independent variable on the dependent variable, a combinatorial impact. A more extensive discussion of existing ANOVA techniques can be found at http://www2.chass.ncsu.edu/garson/pa765/anova.htm. A copy of this document which was downloaded on Nov. 5, 2004 and is being submitted as a disclosure document in this application, is hereby incorporated herein, in its entirety, by reference thereto.

Multivariate, or N-way ANOVA addresses N independent variables. As the number of independent variables increases, the number of potential interactions proliferates. For example, the consideration of two independent variables A and B considers only a single first-order interaction (AB). Consideration of three independent variables A, B and C requires analysis of three first order interactions (AB,AC,BC) and one second-order interaction (ABC). Consideration of four independent variable requires a consideration of six first-order (AB,AC,AD,BC,BC,CD), three second-order (ABC, ACD, BCD), and one third-order (ABCD) interactions, or ten interactions in all. As the number of interactions increases, it becomes increasingly difficult to calculate the model estimates. Even for models having only a few ANOVA variables, the same problems may be experienced when there are many nominal or ordinal levels to one or more of the variables.

Analysis of variance in biological applications, for example, typically present vary large numbers of variables, making it extremely difficult, time consuming and costly to calculate results. Depending upon the characterizations of the variables, it may be practically impossible to apply current analysis of variable techniques and expect to achieve results because of the enormity of the calculations required. For example, in applications such as genomics, it is not atypical to be faced with data-analysis problems involving multiple categorical variables that can have tens of thousands of levels, such as gene names or probe designations, as just two examples of many. Interactions among such variables may produce tens of millions of data columns. Such columns for this example, however, tend to be sparse in that the variables mentioned can be represented as nominal variables. Large matrices of columns sparsely populated by data can typically be reduced to smaller matrices, especially when there is some pattern in the sparsely populated data columns that can be identified. The smaller matrices are much more computationally manageable, making analysis of variance techniques practically useable when only nominal variables are being considered.

However, when considering factors that reflect process conditions associated with processing the probes, these factors are represented by variables that are categorical (class) variables, such as ordinal or nominal and scaled variables with a continuum of levels, the data columns of which are typically non-sparse. The inclusion of non-sparse data columns into a matrix to be analyzed by least squares optimization makes it impossible to reduce the matrix size by any effective amount, leaving enormous numbers of calculations to be performed. Statistical analysis by well-known software products, such as JMP*SAS (http://www.jmp.com/) and SAS, for example, can take days to process such data due to limitations in memory and CPU speed on a typical computer running the software.

### SUMMARY OF THE INVENTION

Methods, systems and computer readable media for fast analysis of variance are provided, wherein a large number of variables including nominal and/or ordinal variables as well as scalar variables are considered in the analysis. The variables may be modeled relative to one or more measured outputs according to the equation:
XB=Y
where
X is a matrix containing rows and columns of data representing the variables;

Y is a vector or matrix with a column for every actual dependent variable of the measured outputs; and

B is the solution matrix or vector containing a column for each response column in Y, that defines the effects of the variables in X.

The columns of the matrix X may be partitioned into q mutually exhaustive bins of columns, and then the solution matrix is iteratively solved for by iteratively solving for values of the solution matrix of the model for each bin 1 to q for a complete pass through the entire X matrix. These iterations may be repeated for a number of passes until changes in calculated values of the solution matrix B over a complete pass become smaller in magnitude than a predetermined threshold magnitude, or until a preset maximum number of complete passes have been performed, as necessary to end a possible but improbable cycle convergence.

Methods, systems and computer readable media are provided for fast linear regression for modeling effects of multiple variables on uni-variable or multi-variable outputs, including subdividing a matrix containing rows and columns of data representing the multiple variables into q mutually exhaustive bins of columns, each said column representing one of the multiple variables; applying a modified Gauss-Seidel algorithm iteratively to said bins for all 1 to q bins for a pass through the matrix; and repeating the iterative applications of the modified Gauss-Seidel algorithm over a number of passes until changes in calculated values of a solution matrix B resultant from linearly regressing the output/response variables on the matrix containing the multiple input/predictor variables over a complete pass of all bins, become smaller in magnitude than a predetermined threshold magnitude, or until a preset maximum number of complete passes have been performed, as necessary to end a possible but improbable cycle convergence.

Further provided are steps of condensing a matrix having sparse columns representative of nominal and/or ordinal variables, and carrying out iterative solving for a solution matrix based on values in the condensed matrix.

Still further, forwarding, transmitting and/or receiving a result obtained from any of the methods described herein are disclosed.

These and other advantages and features of the invention will become apparent to those persons skilled in the art upon reading the details of the methods, systems and computer readable media as more fully described below.

### BRIEF DESCRIPTION OF THE DRAWINGS

FIG. 1 is a schematic representation of a matrix representing large numbers of nominal variables and also some scaled and/or ordinal variables to be considered for analysis of variance. For purposes of practicality, given the limitations of the drawing, only one nominal (i.e., ANOVA) variable is shown having m levels.

FIG. 2 shows binning of the columns of the matrix of FIG. 1, as well as an outputs or measurements matrix Y with multiple different Y columns.

FIG. 3 is a flowchart illustrating events that may be carried out for fast analysis of variance according to one embodiment of the present invention.

FIG. 4 illustrates a typical computer system that may be employed in a system as in accordance with an embodiment of the present invention, and/or to carry out a method or instructions on computer readable media according to the present invention.

FIG. 5 is a schematic representation of an X matrix and Y matrix (in this case vector) as set up for carrying out regression analysis according to the present invention.

FIG. 6 is a schematic representation of the Y matrix (in this case, a vector) shown in FIG. 5, and a condensed form of the X matrix.

FIGS. 7A and 7B illustrate rows of calculations performed based on use of a condensed matrix according to the present invention.

### DETAILED DESCRIPTION OF THE INVENTION

Before the present methods, systems and computer readable media are described, it is to be understood that this invention is not limited to particular examples or embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a column” includes a plurality of such columns and reference to “the variable” includes reference to one or more variables and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### DEFINITIONS

A “nominal variable” is a variable the levels of which are just names to distinguish that to which they are assigned. Nominal variables cannot be ordered or scaled. For example, writers used in manufacturing microarrays can be tracked using nominal variables (e.g., “writer 1, writer 2, writer3, etc.” or “1, 2, 3, etc.”) where the nominal variables assigned do not relate to any order or position of the writers.

An “ordinal variable” is similar to a nominal variable, but additionally, the variable assigned have order, although they cannot be scaled. For example, in a race, runners can be assigned ordinal variables as to the positions that they finish the race in. Thus, the variables “runner 1, runner 2, runner 3, etc” have meaning not only to identify the runners to which they were assigned, but also designate the places that the runners finished in, respectively. However, scaling of these variables is not possible. For example, there is no way to tell, from these variables, how close runner 2 finished to runner 1 in comparison with how close runner 2 finished to runner 3, etc.

A “scaled variable” is one in which levels are based on a number system, such that ordering and scaling of the levels are possible. Interpolation between scaled variables is possible, e.g., it is possible to interpolate between two adjacent time variables (which are an example of scaled variables) such that an interpolated value of forty-five seconds can be computed from adjacent values of forty seconds and fifty seconds.

A “microarray”, “bioarray” or “array”, unless a contrary intention appears, includes any one-, two-or three-dimensional arrangement of addressable regions bearing a particular chemical moiety or moieties associated with that region. A microarray is “addressable” in that it has multiple regions of moieties such that a region at a particular predetermined location on the microarray will detect a particular target or class of targets (although a feature may incidentally detect non-targets of that feature). Array features are typically, but need not be, separated by intervening spaces. In the case of an array, the “target” will be referenced as a moiety in a mobile phase, to be detected by probes, which are bound to the substrate at the various regions. However, either of the “target” or “target probes” may be the one, which is to be evaluated by the other.

Methods to fabricate arrays are described in detail in U.S. Pat. Nos. 6,242,266; 6,232,072; 6,180,351; 6,171,797 and 6,323,043. As already mentioned, these references are incorporated herein by reference. Other drop deposition methods can be used for fabrication, as previously described herein. Also, instead of drop deposition methods, photolithographic array fabrication methods may be used. Interfeature areas need not be present particularly when the arrays are made by photolithographic methods as described in those patents.

Following receipt by a user, an array will typically be exposed to a sample and then read. Reading of an array may be accomplished by illuminating the array and reading the location and intensity of resulting fluorescence at multiple regions on each feature of the array. For example, a scanner may be used for this purpose is the AGILENT MICROARRAY SCANNER manufactured by Agilent Technologies, Palo, Alto, Calif. or other similar scanner. Other suitable apparatus and methods are described in U.S. Pat. Nos. 6,518,556; 6,486,457; 6,406,849; 6,371,370; 6,355,921; 6,320,196; 6,251,685 and 6,222,664. However, arrays may be read by any other methods or apparatus than the foregoing, other reading methods including other optical techniques or electrical techniques (where each feature is provided with an electrode to detect bonding at that feature in a manner disclosed in U.S. Pat. Nos. 6,251,685, 6,221,583 and elsewhere).

When one item is indicated as being “remote” from another, this is referenced that the two items are at least in different buildings, and may be at least one mile, ten miles, or at least one hundred miles apart.

“Communicating” information references transmitting the data representing that information as electrical signals over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

A “processor” references any hardware and/or software combination which will perform the functions required of it. For example, any processor herein may be a programmable digital microprocessor such as available in the form of a mainframe, server, or personal computer. Where the processor is programmable, suitable programming can be communicated from a remote location to the processor, or previously saved in a computer program product. For example, a magnetic or optical disk may carry the programming, and can be read by a suitable disk reader communicating with each processor at its corresponding station.

Reference to a singular item, includes the possibility that there are plural of the same items present.

“May” means optionally.

Methods recited herein may be carried out in any order of the recited events which is logically possible, as well as the recited order of events.

All patents and other references cited in this application, are incorporated into this application by reference except insofar as they may conflict with those of the present application (in which case the present application prevails).

A typical approach using analysis of variables, where the variables are nominal variables, assigns a value to each level, typically as a one in a data column for a level representing the presence of that particular condition that the variable is describing, or a zero for absence of that condition. An example of such an analysis may include the following nominal variables: machine used, operator of the machine, wafer, array, barcode, sample, etc., i.e., entities to which nominal labels can be applied. In this example, various combinations of the entities represented by the nominal variables can be and are used in preparing various samples, such as DNA samples, for example. An analysis of variance endeavors to determine how much each of the variables being considered contributes to variability in results. Thus, in this example, a researcher is interested in how much the particular machine used contributes to variability in results, how much the barcode used contributes to variability, how much the array contributes to variability, how much the operator contributes to variability, etc. The approach generates a total sum of squares from all of the data representative of the nominal variables and that represents the total variability in the data. Then the total sum of squares is partitioned to represent contributions from each of the nominal variables considered, to reflect the relative amount that each variable contributes to variability. Inherent to this approach is the assumption that the variables adequately represent and cover the space of the application. Otherwise, if the variables do not adequately represent or cover the space of the application (e.g., such as in the case of a random sample), then complex methods such as variance components for inference to the complete space of the functional application must be applied.

When scaled variables are considered along with the nominal/ordinal variables, the rows and columns of data representative of the scaled variables are dense, making calculations to find sum of squares very technically challenging, so that an inordinate amount of computer time is required when a problem can be solved at all. Examples of scaled variables include signal intensity levels across an array, temperatures, pressures, etc. A continuous functional relationship can be developed from the scaled variable data and the function can be used to calculate sum of squares values, that can be combined with the sum of square values calculated for the nominal variables to give a total sum of squares. Further details regarding developing continuous functional relationships are described in co-pending commonly owned application Ser. No. 10/422,570 field on Apr. 23, 2003 and titled “Microarray Performance Management System”. application Ser. No. 10/422,570 is hereby incorporated herein, in its entirety, by reference thereto.

A problem with solving large variable models of interrelationships such as those analyzed by analysis of variables approaches, complex biological array (CBA) metrics, scaled metrics or the like when analyzing scaled variables along with large numbers of nominal variables as described is the unwieldy amount of calculations that need to be performed when dense data columns and rows are considered along with larger numbers of sparse data columns and/or rows, as described above.

A statistical model that may be used to analyze such problems having a large number of variables is
XB=Y (1)
where

X is a matrix containing rows and columns of data representing the effects or factors by nominal and/or ordinal and/or scaled variables;

Y is a vector or matrix with a column for every actual dependent variable of readings of what is being measured (such as intensity plus noise, for example); and

B is the solution matrix or vector containing a column for each response column in Y, that defines the effects of the independent variables (nominal and/or ordinal and/or scalar) on the outcome (e.g., intensity values).

Thus for a study of intensity, for example, the model can include all of the factors that may effect variability in intensity, as well as noise factors (useful in determining a measure of reliability of the intensity readings), such as, for example, manufacturing factors (wafer factors, synthesis (writer) factors, slides, positions of slides on wafers, and many other variables) hybridization factors, including many nominal variables as well as scaled variables. The levels for nominal variables can generally be indicated by simple flagging, e.g., either writer one is being used (assign a value of 1) or it is not (assign a value of zero). This results in a high dimensional space but very sparse data. For example, if there are one hundred different process conditions that are to be considered with a batch of microarrays to study variability or quality and the effects on the same from each of the factors considered, then for each microarray process condition 1, each row or column of the overall matrix X that reflects the condition state 1 will have a one in the cell reflecting condition 1 and a zero in the ninety-nine other cells reflecting the other conditions. A similar situation exists with regard to use of each of the other ninety-nine conditions, except for one for purposes of avoiding singularity results in calculations as further described below. For example, a column in which all cells are populated with “one” values may be provided, whose B parameters effectively represent the center of each response column as optimized by least squares regression. This column full of one values is sometimes referred to as the “intercept column”. For an example with five writers, one writer (e.g., writer no. 5) can be used to help define these response centers, while the other four writers are represented as shifts from the center of each Y-response. Hence, a vast portion of matrix X that reflects the nominal variables is very sparse indeed. Further, because there is no way to interpolate between nominal variables (e.g., it does not make sense to refer to writer 1.5, since there is no writer that exists between writer 1 and writer 2) a continuous function cannot be developed to describe such variables.

A pure ANOVA model, i.e., a model having only nominal variables can be run very quickly on a typical computer used in a bioresearch lab or in the office of a bioresearcher, based on least squares regression, using techniques for reducing the size of the X matrix when it is very large due to a large number of nominal variables, since the data will be very sparse in that matrix (e.g., regression matrix may be able to be blocked, diagonalized, or otherwise reduced based upon a pattern formed by the sparse data).

Scaled continuous variables (e.g., gradients across arrays, temperature, actual row and column positions on arrays, etc.) on the other hand, are inherently orderable, scalable and continuous and thus can be interpolated, such that continuous functions can be developed to describe scaled variables and so that values can be interpolated between the known or given values for such a variable. Likewise, a model containing only scaled variables can typically be readily processed on a standard computer such as found in a bioresearch lab or a researcher's office, based on least squares regression. Although such a model works with a matrix having densely populated row and column data, and thus does not show any easily reducible patterns, there are typically nowhere near as many rows and columns in a scaled variable model as there are in a nominal variable model. Given the practical range of number of columns of scaled variables that are typically presented for processing, such a model is typically relatively fast and easy to process.

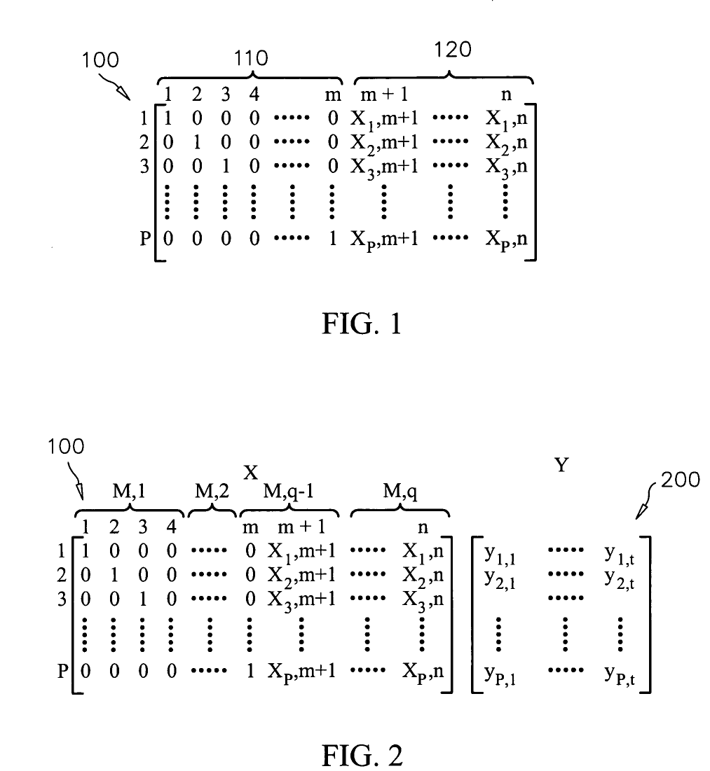

Problems arise when a model contains large numbers of nominal variables 110 and also some scaled and/or ordinal variables 120 as schematically represented in the matrix 100 of FIG. 1. For example, it was not possible, within a practical amount of time to solve a problem including four arrays with 1,400 probes each with five columns of gradient measurements (scaled vectors) an intercept term column (scaled vector) and five other columns of representing scaled vectors. In such a situation, the regression matrix 100 no longer has a simple pattern as it would if only large numbers of nominal variables were being considered, since a portion of the matrix contains the dense data resultant from the scaled (and/or ordinal) variables that does not have a simple pattern. Thus, the combination of these columns eliminates the ability to reduce the sparsely populated data under columns 110, so that enormous numbers of calculations must be carried out to process the model. Such matrices may be so large that they may not be able to be solved by the conventional approaches referred to above, even on computers that are more powerful than those that are typically found in a research laboratory or in a researcher's office. For example, such a model may have millions or billions of variables, i.e., n=millions or billions. The least squares solution is an n² problem to solve and n² becomes very unwieldy in such an example, since the least squared terms in B are given by:
B=(X′X)⁻¹X′Y (2)
and the sum of squares of errors are given by:
SQE=Y′[I−X(X′X)⁻¹X′]Y (3)
where
SQE designates sum of squares of errors, and
I designates the identity matrix.

The component (X′X)⁻¹X′ is known as a projection operator that functions to project the data from a data vector manifold space down to the model parameter manifold, for a model that is being used to model the data. The projection of the data onto the plane of the model (the manifold) indicates what portion of the data that the model can cover or describe. What the model can't fit are called residuals or errors (residual manifold space).

When the X matrix (matrix 100 in the example referred to in FIG. 1) is so enormous and does not exhibit a simple pattern, as when both large numbers of nominal/ordinal variables and some practical number of scaled variables are represented (i.e., wherein although the portion of the matrix representative of the nominal variables typically exhibits a simple, sparse pattern, the portion representative of the scaled/ordinal variables does not, and inverting such a matrix and multiplying as required in equation (2) above, eliminates the simple pattern in the result, and even during the computation), then it is very computationally challenging to invert the matrix X as required by equation (2). Further, the calculation of X′X is computationally challenging and time consuming.

In order to make such a model manageable, an approach taken by the current inventor involves an optimization of B in the over-determined statistical matrix system given by equation (1), into an iteration of smaller problems by solving equation (2) iteratively, as by using fast Fourier transforms (FFT), for example. The iterations may be performed with regard to partitioned columns of the very large matrix X (or, alternatively, partitioned rows when the number of rows is exceedingly large) to significantly reduce the magnitude of the number of calculations that must be performed to solve any one iteration. Thus matrix X is partitioned into q mutually exclusive, exhaustive bins of columns (or alternatively, rows), with each bin indexed by j, i.e., j=1, 2, . . . , q. The bins may be of arbitrary size (e.g., numbers of columns) with the caveat that viable/rational number sizes speed convergence to a solution. It is further noted that the bins can be of unequal sizes relative to each other. A current guideline used in selecting bins is to keep nominal/ordinal variables in bins separate from those containing scaled (continuous) variables, and vice versa. Although this is not a necessary condition, it does facilitate the use of sparse matrix methods for processing the bins containing the nominal/ordinal variable columns or rows.

For any matrix M, by defining M,ⱼ as the j^{th} bin of columns, see FIG. 2, (or, alternatively, Mⱼ, as the j^{th} bin of rows), and defining M_{[,j]} as M with the j^{th} bin of columns deleted (or, alternatively, M_{[j,]} as M with the j^{th} bin of rows deleted), then to solve for B in equations (1)-(2), an estimate for B is used to carry out the first iteration, where

Bⱼ⁰=estimate, for all bins j=B⁰, note Bⱼ≈B_{j,}.(see equations (4)-(9) below).

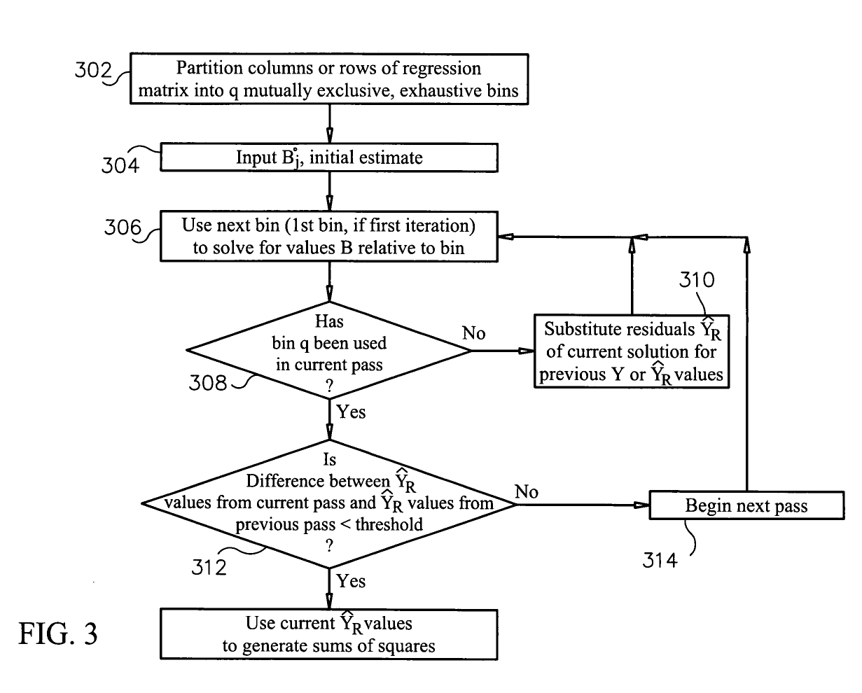

For example, univariate initial estimates may be used for B⁰ estimate and its associated Ŷ_{R}, where correlations among columns (or rows) of scaled variables and columns (or rows) of nominal/ordinal variables are ignored. After partitioning the column or rows of matrix X in a manner described (see FIG. 3, event 302), and using the initial estimate (see FIG. 3, event 304), the first bin (e.g., X₁ where the number of columns in the bin may be any number from 1 to n), equation (2) is then solved in terms of X₁ at event 306. Assuming that there is more than one bin, at event 308, it will be determined at this stage that not all q bins have been considered. In such case, the residuals Ŷ_{R} from the solutions after solving using the current bin (e.g., first bin, in the current iteration being described) are then used to substitute for the measurements or “Y values” or previous residuals Ŷ_{R}, at event 310, wherein Y may be a vector or matrix 200 as shown in FIG. 2. Updating may be carried out immediately for a current bin, or updating may be delayed until all bins have been processed on a current pass, at which time all bins may be updated. The latter option requires multivariate update methods such as conjugate gradient, Marquardt-Levenberg procedures, or use of a low pass filter, such as a Holt-Winters low pass filter applied to the series of complete passes, for example. Using the former option (the simpler immediate bin/partition update method), after updating the current bin, the next bin is then used at event 306 to substitute for X in equation (2) to carry out the next iteration and new B values are calculated based upon the new bin and the current residual values Ŷ_{R}. With each iteration, the values for B that are calculated are considered to be the best solution from all previous solutions. That is, given the number of columns or rows that have been considered up to the time of that particular iteration, the values for B are the best solution to characterize Y. An iteration k+1, where k+1≦q is characterized according to the following:
X_{,j}B_{j,}^{k+1}=(Y−X_{[,j]}B_{[j,]}^{k}) (4)

where Y−X_{[,j]B}_{[j,]}^{k} is the residual of the values of Y after subtracting the best solution values from the previous iteration. Rearranging and solving for the least squares terms of the solution for the current iteration, based on the prior solution gives:
B_{j,}^{k+1}=[X′_{,j}X_{,j}]⁻¹X′_{,j}(Y−X_{[,j]}B_{[j,]}^{k}) (5)
and
B_{j,}^{k+1}=[X′_{,j}X_{,j}]⁻¹X_{,j}(Y−XB^{k}+X_{,j}B_{j,}^{k}) (6)

where X′_{,j}X_{[,j]}B_{[j,]}^{k}=X′_{,j}(XB^{k}−X′_{,j}(Y−XB^{k}).

Rearranging gives:
B_{j,}^{k+1}−B_{j,}^{k}=[X′_{,j}X_{,j}]⁻¹X′_{,j}(Y−XB^{k}) (7)

The difference between the estimated k^{th} solution and the estimated solution for the k+1^{st} iteration is:
(Y−XB^{k})ⱼ^{k+1}−Y−XB^{k}+X_{,j}B_{j,}^{k}−X_{,j}B_{j,}^{k+1} (8)
or
(Y−XB^{k})ⱼ^{k+1}=Y−XB^{k}−X_{,j}Δ_{j,}^{k+1} (9)
where Δⱼ^{k+1}=Bⱼ^{k+1}−Bⱼ^{k}.

The above approach is a generalization of the Jacobi and Gauss-Seidel algorithms and matrix-splitting concepts described in Golub and Van Loan (Matrix Computations, 2^{nd} edition, which is incorporated herein, in its entirety, by reference thereto) and applies to problems involving statistical analysis with blocks of columns/variables with different data properties, whereas the Jacobi and Gauss-Seidl algorithms apply only to square matrices, e.g., square matrix A (i.e., alias X) solving for “x” (Alias B), also known as a “saturated design”, meaning that, if applied to a problem of the type described in this disclosure, the Jacobi and Gauss-Seidl algorithms are left with no degrees of freedom (manifold for errors) so that the statistical properties of such an approach are poor to non-existent.

B-updates may be performed sequentially for each bin or in parallel for all bins. Further, updates may be improved by conjugate gradient or Marquardt-Levenberg modifications. Conjugate gradient techniques consider second-order impacts on the optimization process. A more extensive discussion of conjugate gradient techniques can be found at http://mathworld.wolfram.com/ConjugateGradientMethod.html. A copy of this document which was downloaded on Nov. 24, 2004 is being submitted as a disclosure document in this application, and is also hereby incorporated herein, in its entirety, by reference thereto.

The Marquardt-Levenberg method is described in more detail in co-pending commonly owned application Ser. No. 10/422,570 (which was already incorporated by reference above) and in co-pending, commonly owned application Ser. No. 10/400,372 filed Mar. 27, 2003 and titled “Method and System for Predicting Multi-Variable Outcomes”. application Ser. No. 10/400,372 is hereby incorporated herein, in its entirety, by reference thereto. Further, application Ser. No. 10/400,372 claims the benefit of Provisional Application No. 60/368,586 and Provisional Application No. 60/368,586 is also hereby incorporated herein, in its entirety, by reference thereto.

After processing iterations of all bins in a first pass of the problem, it is determined that bin q has been processed for the current pass at event 308. At this time, it is considered at event 312 whether differences between the residuals ( or B values) from the current pass and the residuals (or B values, respectively) from the previous pass are less than acceptable threshold values, where threshold values may be previously determined. Threshold values may be set by a person or persons of skill having numerical and practical expertise in the domain of the specific application to which the current methods are applied for analysis. At the stage currently described, there has been only one pass, so that there are no differences to calculate. Accordingly, a next pass is initiated at even 314 where iterations of all bins are processed according to events 306-310 beginning with the latest set of residual values from the previous pass. After all q bins have again been processed in the current pass, then it is considered again at event 312, whether the differences in the current residual values and residual values at the end of the previous pass are within the accepted tolerances. Iterations are typically carried out until the delta elements (i.e., “Δ”'s in equation (8)) become smaller in magnitude than an accepted and/or predetermined threshold magnitude, or alternatively, until a preset maximum number of iterations have been performed, as necessary to end a possible but improbable cycle convergence. Once the values are within tolerance, then the most current Y-residual values are used at event 316 to generate error sums of squares values for use in determining ANOVA/regression statistical significance according to least squares methodology as determined by the best values for B, which do the best job of fitting the Y columns based upon matrix X. While least squares regression is typically best for normal errors, e.g., Gaussian distributed errors, other known methodologies may alternatively be applied to solve for the best values for B, including known methodologies such as Min-Max Entropy, Maximum Entropy, or Maximum Likelihood.

Sparse methods may be used for sparse bins. For sparse bins, the processing described by the equations above may be designed to ignore zero values in all ordinal and nominal columns that are inherently sparse, i.e., that contain all zeros except for one value, or that contain greater than a predetermined number or percentage of zeros, an example of which is demonstrated in FIGS. 1 and 2. Typically, scaled columns are not sparse, as noted above. However, in the rare event that a scaled column does exist as inherently sparse, the sparse methods indicated above may also be applied to one or more such columns. The sparse methods use one column to capture non-zero entries from as many columns as possible in one column, so as to conserve computational efficiency.

For example, consider a nominal or ordinal variable that describes array writers, where there are five writers, which can be expressed by five levels of the variable. In this case, using sparse methods, one column captures all information for the writer variable, with 1,2,3,4 or 5 used as labels to indicate the writer source. “1”, “2”, “3”, “4” and “5” are not treated as numbers during the processing, but are expanded to five flagging columns (i.e., one per level) each with entries of “1” or “0” only. Note that typically these columns are transformed, but the sparsity is preserved. The present system solves the iteration equations over all bins without expanding the single column in the example above to the five sparse columns, thus saving large amounts of memory that would otherwise be used to store the additional columns with all the zeros. Also, by using the single column (or reduced number of columns when more than one sparse variable is being treated by sparse methods, for example) computational efficiency is vastly improved, greatly reducing the amount of time needed to calculate solutions, since an enormous number of zeroes (and columns) can be eliminated from computational processing. Hence the compressed column or columns map directly to the regression columns (i.e., non-compressed columns or columns of the X matrix) so there is no need to actually use the regression columns that require a very substantial amount of storage space (typically comprising at least about 40% zeroes) and require a lot of unnecessary computations, as described above. In the example immediately above, the values 1,2,3,4 and 5 of each row in the compressed column may be expanded to multiple columns with values of 1000, 0100, 0010, 0001, and -1-1-1-1. Thus a sparse bin that may be compressed according to the sparse methods described will typically comprise at least about 40% zeroes.

Ridge-conditioning may be applied to correct for rank-deficiency properties of X. X-columns (or rows, as the case may be) are not independent. For example, there may be linear or near-linear relations among X-columns. Ridge-conditioning inserts an artificial row to effectively correct to full rank, a rank deficient X to enable calculation of a rank-deficient solution with only a small bias resulting from such technique. Hence ridge conditioning may provide a Least Squares solution in this situation unless the solution is singular, as in the case of nominal variables. Nominal columns are inherently interdependent, but may be transformed into sparse independent columns. One example of ridge-conditioning that may be applied is ridge regression or Tikhonov regularization, the details of which are described in “Ridge regression/Tikhonov regularization” at www.gps.caltech.edu/˜tapio/acm118/Handouts/ridge.pdf. A copy of this document which was downloaded on Nov. 24, 2004 is being submitted as a disclosure document in this application, and is also hereby incorporated herein, in its entirety, by reference thereto.

The sum of squares contributions from all the different variables in matrix X may be determined by using the present techniques and can then be used for quality control purposes. Such contributions may be determined by differential errors sums of squares (e.g., least-squares model with selected variable(s) left out in order to observe the impact that the omitted variable(s) has/have on the error sum of squares results. For example, when producing microarrays, it may be determined whether the operator is important, whether the machine is important, whether the writer is important, etc. When one or more of these variables is considered to be “important” or a “sensitive” variable, i.e., important to predicting the Y values (outcome or product), then adjustments, more sensitive monitoring, or other particular attention can be paid to the important variables to improve the quality of the output Y and/or maintain a desired level of quality control. Furthermore, the contributions may be ranked and/or further processed to determine the relative importance of the variables, based on their impact on error sum of squares, by a technique known as Type IV ANOVA. Thus, for a total sum of squares given as:
TSQ=Σ(Y−\overline{Y})² (10)

where \overline{Y} is the average Y value over all the data in Y, and a difference between each Y value and the average Y value is calculated and squared, respectively, and then those squared values are summed.

Each value for Y−\overline{Y} is a measure of how far that particular measurement of Y varies from the average. The variability in Y from the average measured value of Y is due not only to noise factors, but also some factors over which a quality control manager may have some control to change or correct. Specifically, the variables that are represented in the X matrix will have some impact on the variability in the Y values measured. By further statistically manipulating the entries in the X matrix, the sum of squares methodology may be applied to determine how much effect a particular variable or group of variables has on variability in the measured outcome values Y. For example, if there are ten operators total being considered in matrix X, then it may be interesting to know how much each operator contributes to variability, and comparisons among operators can be made from those results if desired. Or, it might be of interest to see how much operators as a group contribute to variability versus the amount of variability owing to the writers. There are many different calculations and comparisons that can be generated based on the great number of variables to consider.

Using statistical methods such as t-tests, for example (see co-pending application Ser. No. 10/821,829 filed Apr. 9, 2004 and titled Methods and Systems for Evaluation and for Comparing Methods of Testing Tissue Samples” (which is hereby incorporated herein, in its entirety, by reference thereto)) the ANOVA sum of squares, SSQ, can be used to measure the relative contributions to the total sum or squares from each column/row (i.e., variable) or from groups of columns/rows (variables) as desired:
TSQ=Σ(Y−\overline{Y})²=SSQ_{col1}+SSq_{col2}+ . . . +SSQ_{coln}+RSQ (11)
where SSQₓ refers to the contribution to the total sum of squares by column(s) (x) beyond the SSQ of all previous column(s), and RSQ refers to the residual sum of squares that cannot be accounted for by all columns by the described techniques and is considered to be random error. Of course the component sums of squares need not be broken down to individual variables only, as they may be broken down according to any exclusive, exhaustive subsets of the set of variables as desired. Accordingly, the described techniques are statistical techniques for accounting for variability in the outcome data Y and determining the relative amount of causation of the variability owing to different variables in X.

The sum of squares can be represented in at least two ways: forward sum of squares (Type I) or backward sum of squares (Type IV). Type I model sum of squares measures the importance of columns progressively as the number of columns considered is progressively increased to the full model and may be characterized by:
SSQ_{B}=Y′X_{A+B}(X_{A+B}′X_{A+B})⁻¹X_{A+B}′Y−Y′X_{A}(X_{A}′X_{A})⁻¹X_{A}′Y (12)
Note that the above equation is the same as describing the differences in residual sum of squares of “model A” minus that of model “A+B”.

Each successive component sum of squares calculation is performed subject to all calculations for previous sums of squares. For a simplified example in which a much smaller number of variables is discussed to make the explanation easier, though still pertinent to much larger number of variables, consider the following example of Type I forward sum of squares (model building) approach:
TSQ=SSQ_{cols1-10}+SSQ_{cols11-15}+SSQ_{cols16-20}RSQ (13)

for a matrix X having 30 variables total. The total sum of squares is equal to the sums of squares from each partition/bin plus the residual sum of squares. In this instance, the sum of squares component for columns 1-10 is calculated by partitioning the first 10 columns of matrix X and substituting it for X in equation (11) above. After calculating the sum of squares component attributable to columns 1-10 i.e., Σ(Y−Ŷ)², using a forward sum of squares technique, the sum of squares component for columns 11-15 is calculated with consideration of the first 1-10 columns being taken into account. The first 1-10 columns are taken into account by using residual values Ŷ that result from removing the contributions of the first 10 columns from the Y values. Similarly, the sum of squares component for columns 16-20 is calculated after already taking into account the effect of columns 1-15, i.e., based on the residual values resultant from performing the sum of squares component calculation for columns 11- 15.

Alternatively, backward sums of squares (i.e., Type IV, model testing) techniques may be used. Once the total solution has been estimated, projection to any of the partial solutions (component sums of squares) can be made. By comparing specific reduced models to the full model sum of squares, residual sums of squares can be determined, which form a measure of the impact that the variable(s) omitted from each reduced model has/have on the outcome, respectively. It should be noted that the sum of all sums of squares for any set of exhaustive, exclusive Type IV reduced models does not equal total sum of squares for the full model.

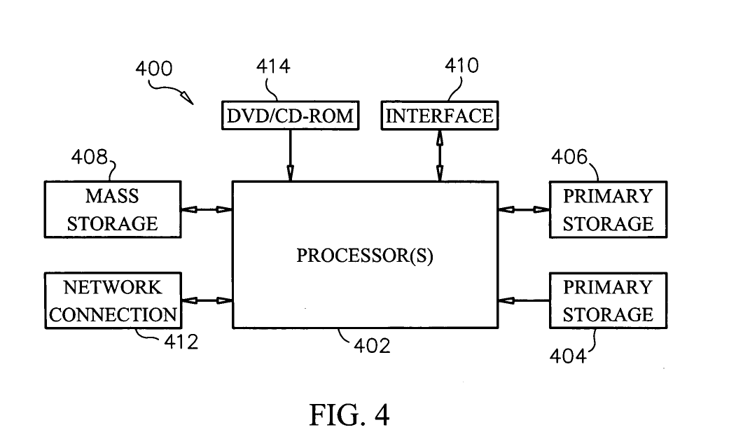

FIG. 4 illustrates a typical computer system in accordance with an embodiment of the present invention. The computer system 400 includes any number of processors 402 (also referred to as central processing units, or CPUs) that are coupled to storage devices including primary storage 406 (typically a random access memory, or RAM), primary storage 404 (typically a read only memory, or ROM). As is well known in the art, primary storage 404 acts to transfer data and instructions uni-directionally to the CPU and primary storage 406 is used typically to transfer data and instructions in a bi-directional manner Both of these primary storage devices may include any suitable computer-readable media such as those described above. A mass storage device 408 is also coupled bi-directionally to CPU 402 and provides additional data storage capacity and may include any of the computer-readable media described above. Mass storage device 408 may be used to store programs, data and the like and is typically a secondary storage medium such as a hard disk that is slower than primary storage. It will be appreciated that the information retained within the mass storage device 408, may, in appropriate cases, be incorporated in standard fashion as part of primary storage 406 as virtual memory. A specific mass storage device such as a CD-ROM or DVD-ROM 414 may also pass data uni-directionally to the CPU. Alternatively, device 414 may be connected for bi-directional data transfer, such as in the case of a CD-RW or DVD-RW, for example.

CPU 402 is also coupled to an interface 410 that may include one or more input/output devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to a computer or telecommunications network using a network connection as shown generally at 412. With such a network connection, it is contemplated that the CPU might receive information from the network, or might output information to the network in the course of performing the above-described method steps. The above-described devices and materials will be familiar to those of skill in the computer hardware and software arts.

The hardware elements described above may implement the instructions of multiple software modules for performing the operations of this invention. For example, instructions for iteratively processing bins of variable data may be stored on mass storage device 408 or 414 and executed on CPU 408 in conjunction with primary memory 406.

In addition, embodiments of the present invention further relate to computer readable media or computer program products that include program instructions and/or data (including data structures) for performing various computer-implemented operations. The media and program instructions may be those specially designed and constructed for the purposes of the present invention, or they may be of the kind well known and available to those having skill in the computer software arts. Examples of computer-readable media include, but are not limited to, magnetic media such as hard disks, floppy disks, and magnetic tape; optical media such as CD-ROM, CDRW, DVD-ROM, or DVD-RW disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

### EXAMPLE

The following example is put forth so as to provide those of ordinary skill in the art with a complete disclosure and description of how to make and use the present invention, and is not intended to limit the scope of what the inventor regards as his invention nor is it intended to represent that the validation test problem below was the only validation and/or test problem performed. Efforts have been made to ensure accuracy with respect to numbers used, but some experimental errors and deviations should be accounted for.

A validation test problem involving one hundred genes with twenty replicates each was run to determine the impact by array row and column effects, that is, to determine what effect placement of a feature on a microarray has on the signal intensity, relative to other locations on the microarray. Thus, the experiment contains only one nominal or ANOVA variable (i.e., “probe” or “feature”) with one hundred levels with twenty replicates each, providing two thousand columns of sparse data (as represented in the X matrix in the above identified equations). Additionally, the two scaled variables (i.e., “row” and “column”) provide two densely populated columns of data in the X matrix. The number of variables (number of columns) was purposely kept to a very low number for problems of this type to allow the problem to be solved by conventional methods so that the solution as provided by the present invention could be validated against the results provided by JMP*SAS.

Column Y is an output produced by measuring some characteristic of the features on the array, so that in this example, in this simulation, Y is a single column matrix or vector, having a value corresponding to each of the two thousand features, respectively. Simulated values need not be actual values since the example is provided only to validate the present methods to prove that the algorithms thereof are effective to provide results at least as reliable as conventional least squares algorithms used on the same data. As noted, a relatively small dataset was provided so that the conventional means were able to calculate a solution.

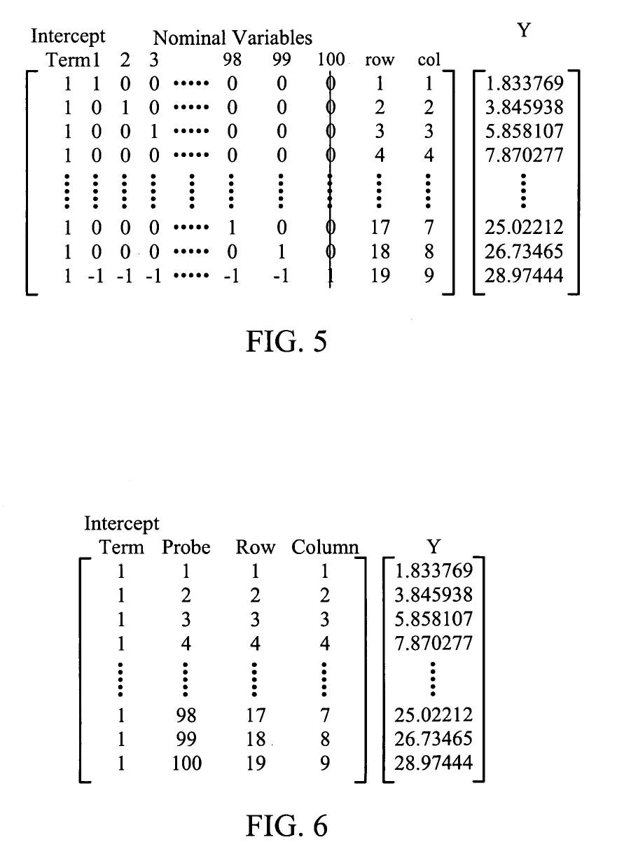

FIG. 5 is a schematic representation of the X matrix and Y matrix (in this case vector) as set up for equation (1) above. Note that only a small portion of the matrix is represented in FIG. 5, since even a “small” problem in this field is in reality quite large, in view of the sparse rows of data that result from the nominal variable. Note that the order of the rows in this matrix (i.e., order in which replicates are represented) is not critical, as the probe replicates are typically spread out over the array, and may be randomly placed. An additional column of data, that may be referred to as the “intercept column” or “intercept term column” was provided as completely populated with a value of one in each cell and which functioned to optimally center the responses (in the Y-column) as described above. The intercept term column functioned to center the data near the mean of the Y values, so that the sum of squares values calculated were with respect to a mean Y value, rather than zero or an origin of the plot of the data. However, when summing across a row of the nominal data, the sum equals one for each row. This sum is equal to the intercept value of one, meaning that the intercept column is a linear combination of the nominal terms and that results in a singular matrix. In order to avoid the singularity problem, the data column labeled 100 in FIG. 5 was eliminated and the twenty rows corresponding to where the twenty replicates of probe 100 were indicated with a 1 were completely filled with values of −1. One such row is shown at the bottom of FIG. 5. In this way, the variable for column 100 can still be accounted for without having the singularity problem discussed above.

The problem identified above was solved by an existing software package, JMP*SAS for purposes of a control for comparison of the present techniques therewith for validation. Although optional, JMP*SAS also implements use of the intercept term column by default and was so used to obtain the results below. The results from the JMP*SAS processing follow:

JMP*SAS results:
Summary of Fit

| | |
|---|---|
| RSquare | 0.983893 |
| RSquare Adj | 0.983035 |
| Root Mean Square Error | 1.002603 |
| Mean of Response | 13.97523 |
| Observations (or Sum Wgts) | 2000 |

Analysis of Variance

| Source | DF | Sum of Squares | Mean Square | F Ratio |
|---|---|---|---|---|
| Model | 101 | 116540.44 | 1153.87 | 1147.883 |
| Error | 1898 | 1907.89 | 1.01 | Prob > F |
| C. Total | 1999 | 118448.33 | | 0.0000 |

The same problem was solved using the present system according to the techniques described herein. FIG. 6 is a schematic representation of the Y matrix (in this case, a vector), and a condensed form of the X matrix from FIG. 5, as used by the sparse methods of the present approach, which eliminates the sparse columns representing the nominal variables. Note that the entry for probe 100 expands to twenty rows each having 99 columns each filled with a value of −1, as described above. These sparse methods not only enormously reduce the number of computations required to solve the problem, but also significantly reduce the storage space required to store the data, even prior to beginning to solve the problem, since the condensed X matrix is very much smaller than the full, expanded matrix X of FIG. 5.

In this example, the simplest approach was taken for binning, wherein each bin was made up of a single column of data. However, as noted above, the present techniques are not limited to such bin assignments, as bins of any size (within the constraints of the problem, e.g., the number of columns available for binning) may be designated.

When solving for B values according to equation (2) above, the calculation for (X′X)⁻¹ and X′R (wherein R is a residual value substituted for the original Y value) the calculations are greatly simplified by breaking the X matrix down and doing step-wise calculations for each bin, as described above.

In this instance, since each bin is merely a sparse vector, the calculations were simple inner products of vectors. That is, the calculation for X′X and X′R were simple inner products, and the inverse of X′X, i.e., (X′X)⁻¹ could be calculated by division: X′R/X′X to give Δ (e.g., ΔB for that particular iteration with respect to the bin that it is being calculated for).

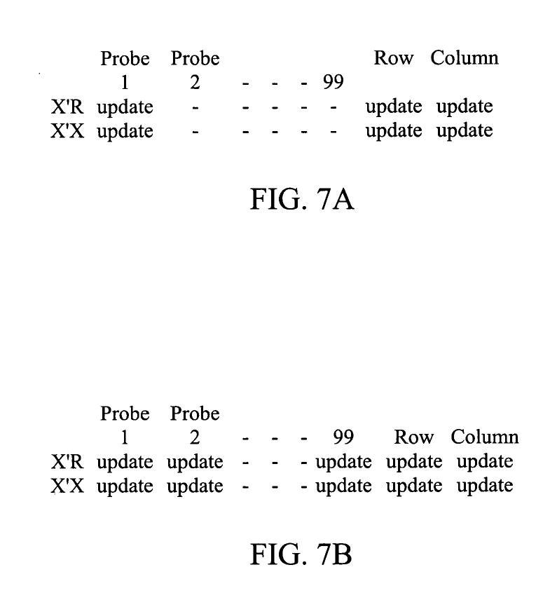

The sparse methods provided herein allow calculations to be carried out without expanding the matrix X to the sparse form. Parallel processing was performed to calculate X′X and X′R values for each bin through the entirety of the data (i.e., a “pass” through the data) after which the calculated values are used to calculate Δ values for B corrections. For example, FIG. 7A illustrates that, using the sparse methods, only six calculations or updates are required to be carried out for probe 1 using sparse methods, as opposed to over four thousand that are required when solving according to traditional approaches.

Additionally, those more than four thousand calculations each require matrix multiplications, rather than vector inner products as carried out by the present approach in this example. The same disparity exists for each of the other probes 2-1999.

However, for probe 2000, which contained a full row of −1 values, for reasons provided above, each column needs to be calculated and updated, as indicated in FIG. 7B, since the row for probe 2000 is filled with nonzero values of −1. Note that it is not required to substitute for the last column of nominal data in this way. Alternatively, any other column of nominal data may be substituted in the same way to avoid the singularity problem, where, in such an instance, column 2000 would then remain as a sparse column. In any event, the probe corresponding to the row of −1 values will require calculations for each column when calculating X′X and X′R, and thus, this particular variable is treated as a dense column, like that of a scalar variable.

A further expedient of the present approach is that, after one pass through the entire matrix, the calculated values for X′X will have been established, and will not change for subsequent passes, since the X values do not change, only the residual values change (R values). Thus, after the first pass, only X′R calculations for each column need to updated with respect to non-zero X-entries only. Thus the sparse methods are very efficient ways to avoid carrying out a large number of unnecessary calculations.

Multivariate correction of the residual values was carried out in this example after each full pass to smooth the data and speed convergence to the final solution. Note that instant corrections (i.e., correction after calculation for each bin within each pass, as opposed to corrections after each full pass only) for each bin (X-bin or B group) is viable if the nominal columns are sorted to group each level as adjacent rows. Hence this enables processing of only a fraction of rows for each nominal level or X-bin, prior to performing a correction.

The objective of the comparison was to note error sum of squares values calculated by each approach, respectively. The following table shows the error sum of squares results from computations by an embodiment of the present system:

### Fast Analysis of Variance (FAN) Results for Error Sum of Squares

### 1907.89

### With Numerical Relative Error

### 5.241 39E-07

The results show that the current fast, sparse, least squares method calculated exactly the same error sum of squares answer that was determined by the conventional least squares approach applied by JMP*SAS.

Simple preprocessing of nominal variables such as a row map of each level speeds processing. This is easily done by use of sort-memory vectors. The C++ coding for the above-described test problem, assuming data sorted by levels of the replicated probe, is reproduced below:

/* fast ANOVA */
#include <windows.h>
//#include <iostream.h>
//#include <fstream.h>
#include <stdlib.h>
#include <math.h>
#include <string.h>
//gv points to XY data, nrw = #rows, ncl = #cols, nn =

#nominal variables

//nx = #X variables (non-nominals), ny = #responses,
//mxl = max #levels of nominals, nit = #iterations allowed
extern “C” int WINAPI fANOVA(float *gv, int& nrw, int&ncl,

int& nn,int& nx,int& ny,int& mxl,int& nit)

{
int k,j,jj,i,np,npt,it=0,jx,jy;
double sxx,sxy,sxx2,sxy2,sm;
int nr1=nrw+1,mxl1=mxl+1,nil=20;
int nc1=ncl+1, rc,mjx,kx,jxa;
float** dd=new float*[nr1];
dd[0]=gv;
jy=nn+nx+1;
for(j=1;j<nr1;j++)dd[j]=dd[j−1]+nc1;
for(it=1;it<nit;it++){

//process intercept-------------------
for(sxy=0,j=1;j<nr1;j++)sxy+=dd[j][jy];
sxy/=nrw;
for(j=1;j<nr1;j++)dd[j][jy]−=sxy;
//process each nominal------------------
for (k=1;k<=nn;k++) {

//process nom levels-------------
for(jj=1;jj<nr1−nil;jj+=nil){

//process last level---------
for(sxy2=sxx2=0,j=nr1−nil;j<nr1;j++){

sxx2+=1;
sxy2−= dd[j][jy];

}
//process level-----------
for(sxy=sxx=0,j=jj;j<jj+nil;j++){
//jx=dd[j][k];

sxx+=1;
sxy+= dd[j][jy];

}
sxy+=sxy2;
sxx+=sxx2;
sxy/=(sxx>0)?sxx:1;
//up y------------------------
for(j=jj;j<jj+nil;j++)dd[j][jy]−=sxy;
for(j=nr1−

nil;j<nr1;j++)dd[j][jy]+=sxy;

}

}//nom end k
//-----------------------------------------------

----

//process each X
for (kx=1;kx<=nx;kx++) {// process Xs

k=nn+kx;
for(sxx=sxy=0,j=1;j<nr1;j++){

sxx+=dd[j][k]*dd[j][k];
sxy+= dd[j][k]*dd[j][jy];

}
sxy/=(sxx>0)?sxx:1;
for(j=1;j<nr1;j++)dd[j][jy]−=sxy*dd[j][k];

}
//------------------------
//if (dl<crt)break;

}//it loop
//crt=dl;
for(sxx=0,j=1;j<nr1;j++)sxx+=dd[j][jy]*dd[j][jy];
gv[0]=sxx;
delete[] dd;
return it;//EXIT_SUCCESS;

}

Note that the lines in the code that begin with “//” describe operational or computational tasks that are being carried out. The XY matrix is inputted with parameters to form “x” number of columns of columns in matrix X and “y” number of columns, which is only one in this example, making Y a vector. The number of nominal variables employed was only one to keep the example simple as a demonstration that the present techniques are valid. The number of scaled variables, number of levels of the nominal variable and number of allowed iterations for processing were also inputted.

Once the error sum of squares has been determined, further analysis, such as Type IV, backward sum of squares (model testing) may be carried out wherein any or all model terms can be tested for sensitivity. By evaluating relative sensitivities of the variables, appropriate strategies can be developed to improve or sustain quality.

For example, to examine the relative sensitivity or weighted effect of any particular variable or group of variables, columns representative of that variable or group of variables are removed from the X matrix and then the procedures of the example described above can be carried out again to produce error sum of squares results. A comparison of the error sum of squares for the current analysis with the error sum of squares for the analysis in which all variable were considered, gives an indication of how much impact the removed variable or variables have on the error or variance in the results of the process being analyzed. Further, by repeating this same procedure with other variables or groups of variables, the results can be compared among various variables or groups of variables to determine which have the greatest impact or sensitivity on the model. For example, the results may be ranked to show an ascending or descending range of impacts by variables/groups of variables. Additionally, or alternatively, an F-test may be applied to determine p-values for the impacts on the error sums of squares resultant from each of the various instances of removal of variables, respectively. Note that these techniques are not limited to the nominal variables, but apply to all variables (columns) in the model, including scaled variables.

The F-Test, if applied, calculates an F-Statistic by a quotient, which, in the numerator calculates the difference in the sum of squares of error (between the sum of squares of error for the total model and the sum of squares of error for the model with one or more variables removed) divided by the difference in degrees of freedom (between the total model and the model with one or more variables removed), and the denominator calculates the sum of squares of error of the total model divided by the degrees of freedom of error for the total model.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, algorithm, results to be analyzed, process, process step or steps, to the objective, spirit and scope of the present invention. All such modifications are intended to be within the scope of the claims appended hereto.

That which is claimed is:

1. A method of analysis of variance comprising the steps of:
modeling variables including nominal and/or ordinal variables as well as scalar variables relative to one or more measured outputs according to the equation:
XB=Y
where
X is a matrix containing rows and columns of data representing the variables;
Y is a vector or matrix with a column for every dependent variable of the measured outputs; and
B is the solution matrix or vector containing a column for each response column in Y, that defines the effects of the variables in X;
partitioning columns of X into q mutually exhaustive bins of said columns;
iteratively solving for values of the solution matrix of the model for each bin 1 to q for a pass through the entire X matrix; and
repeating said iteratively solving for a number of passes until changes in calculated values of the solution matrix B become smaller in magnitude than a predetermined threshold magnitude, or until a preset maximum number of passes have been performed, as necessary to end a cycle convergence.

2. The method of claim 1, wherein said X matrix has greater than or equal to 10,000 columns of data.

3. The method of claim 1, wherein said X matrix has greater than or equal to 20,000 columns of data.

4. The method of claim 1, wherein said X matrix has greater than or equal to 40,000 columns of data.

5. The method of claim 1, further comprising: calculating error sums of squares based upon residual values remaining after a final calculation of a converged, full model of B.

6. The method of claim 5, further comprising calculating total sum of squares and analyzing partial sums of squares relating to selections from the variables to determine relative effects of those selections on error in the model.

7. The method of claim 6, wherein said analyzing comprises Type I forward sums of squares analysis.

8. The method of claim 6, wherein said analyzing comprises Type IV backward sums of squares analysis.

9. The method of claim 1, wherein said variables comprise biological variables.

10. The method of claim 9, wherein the nominal variables comprise variables relating to microarray production.

11. The method of claim 9, wherein the nominal variables comprise variables relating to an experiment carried out on a microarray.

12. The method of claim 1, further comprising the steps of:
condensing matrix X to merge sparse columns of matrix X that predominantly contain zero values; and
carrying out said iteratively solving and repeated passes of said iterative solving steps based on values in the condensed matrix X.

13. The method of claim 6, further comprising modifying one or more of the variables based upon results of said analyzing to improve the quality of Y.

14. The method of claim 13, further comprising repeating all of the steps of claim 6 (including those steps recited in claim 1) to confirm effects upon Y.

15. The method of claim 14, comprising repeating all of the steps of claim 14 (including the steps recited in claims 1, 6 and 13) until a predetermined quality level of Y is achieved.

16. A method of linear regression for modeling effects of multiple variables on uni-variable or multi-variable outputs, said method comprising the steps of:
subdividing a matrix containing rows and columns of data representing the multiple variables into q mutually exhaustive bins of columns, each said column representing one of the multiple variables;
applying a modified Gauss-Seidel algorithm iteratively to said bins for all 1 to q bins for a complete pass through the matrix; and
repeating said iteratively applying the modified Gauss-Seidel algorithm over a number of complete passes until changes in calculated values of a solution matrix B resultant from linearly regressing the output variables on the matrix containing the multiple variables over a complete pass of all bins become smaller in magnitude than a predetermined threshold magnitude, or until a preset maximum number of complete passes have been performed, as necessary to end a cycle convergence.

17. The method of claim 16, wherein the multiple variables represented in the matrix acted on by said subdividing comprise a large number of one of: nominal variables, ordinal variables, and a combination of ordinal variables and nominal variables, and at least one scalar variable.

18. The method of claim 16, wherein the matrix representing the multiple variables contains at least one thousand columns, at least one of said at least one thousand columns being a densely populated column representing a scalar variable.

19. The method of claim 16, wherein the matrix representing the multiple variables contains at least ten thousand columns, at least one of said at least ten thousand columns being a densely populated column representing a scalar variable.

20. A system for performing fast linear regression for modeling effects of multiple variables on uni-variable or multi-variable outputs, said system comprising:
a feature for modeling the multiple variables as a matrix wherein each row of the matrix represents one of the variables or a level of one of the variables of the multiple variables;
a feature for subdividing the matrix q mutually exhaustive bins of columns, each said bin comprising at least one column;
a feature for applying a modified Gauss-Seidel algorithm iteratively to said bins for all 1 to q bins for a complete pass through the matrix for linear regression of the output variables on the multiple variables per bin; and
a feature for repeating said iterative application of the modified Gauss-Seidel algorithm over a number of complete passes until changes in calculated values of a solution matrix B resultant from linearly regressing the output variables on the matrix containing the multiple variables when comparing a current complete pass to a next previous complete pass become smaller in magnitude than a predetermined threshold magnitude, or until a preset maximum number of complete passes have been performed, as necessary to end a cycle convergence.

21. A computer readable medium carrying one or more sequences of instructions for analysis of variance, wherein execution of one or more sequences of instructions by one or more processors causes the one or more processors to perform the steps of:
modeling variables, including nominal and/or ordinal as well as scalar variables, relative to one or more measured outputs according to the equation:
XB=Y
where
X is a matrix containing rows and columns of data representing the variables;
Y is a vector or matrix with a column for every actual dependent variable of the measured outputs; and
B is the solution matrix or vector containing a column for each response column in Y, that defines the effects of the variables in X;
partitioning columns of X into q mutually exhaustive bins of said columns;
iteratively solving for values of the solution matrix of the model for each bin 1 to q for a pass through the entire X matrix; and
repeating said iteratively solving for a number of passes until changes in calculated values of the solution matrix B become smaller in magnitude than a predetermined threshold magnitude, or until a preset maximum number of passes have been performed, as necessary to end a cycle convergence.
